(19) United States
(12) Patent Application Publication
(10) Pub. No.: US 2026/0340708 A1
(43) Pub. Date: Oct. 29, 2026

(54) RECOMMENDATION METHOD AND APPARATUS FOR GROUP

(71) Applicant: UIF (University Industry Foundation), Yonsei University, Seoul (KR)

(72) Inventors: Won-Yong SHIN, Seoul (KR); Jin-Duk PARK, Seoul (KR)

(21) Appl. No.: 19/656,786

(22) Filed: Apr. 23, 2026

(30) Foreign Application Priority Data
Apr. 25, 2025 (KR) 10-2025-0054356

(51) Int. Cl. G06Q 30/0601; G06F 17/16

(52) U.S. Cl. CPC G06Q 30/06313; G06F 17/16

(57) ABSTRACT

A group recommendation method includes: obtaining a member-item matrix representing relationships between users and items, a group-item matrix representing relationships between groups and items, and a member-group matrix representing memberships of users in groups; combining the member-group matrix with the member-item matrix and the group-item matrix, respectively, to obtain an augmented member-item matrix and an augmented group-item matrix, and integrating the member-item matrix and the group-item matrix to obtain a unified matrix; obtaining three similarity matrices representing the similarity between items associated with users, the similarity between items associated with groups, and the similarity between items jointly associated with members and groups; and setting three polynomial matrix filters for the three similarity matrices, and filtering a row vector corresponding to the item recommendation target group in the group-item matrix with a final polynomial matrix filter composed of the three polynomial matrix filters, to obtain a predicted score vector.

### CROSS-REFERENCE TO RELATED APPLICATIONS

This application claims priority under 35 U.S.C. § 119(a) to Korean Patent Application No. 10-2025-0054356, filed on Apr. 25, 2025, with the Korean Intellectual Property Office, the disclosure of which is incorporated herein in its entirety by reference.

### TECHNICAL FIELD

The disclosed embodiments relate to a group recommendation method and apparatus, and more particularly, to a group recommendation method and apparatus utilizing multi-perspective graph filtering.

### BACKGROUND ART

Recommendation systems have had a significant impact across various industries, including e-commerce and content streaming services, through personalized recommendations. The core of a recommendation system is collaborative filtering (CF), which is a method of predicting each user's preferences for various items based on the past item interaction records of multiple users. Conventional collaborative filtering is known to achieve state-of-the-art recommendation performance through the aggregation of high-order neighborhood information using graph neural network models such as Graph Convolutional Networks (GCN). GCN models each user and item as multiple nodes on a graph, and performs neural network operations on the graph constructed with edges connecting nodes according to the relationships between users and items, thereby recommending items suitable for the user.

In general, a recommendation system basically recommends personalized items by considering the item preferences of individual users. However, in some cases, there arises a need to recommend items to a group that includes multiple users as members, which is called group recommendation. Group recommendation aims to provide accurate recommendations customized for a group rather than an individual. For accurate group recommendation, not only the interactions between the group and items but also the interactions between users within the group and items must be considered together.

FIG. 1 is a diagram for explaining the concept of group recommendation.

FIG. 1 illustrates a case of recommending travel destinations as items for a travel group that includes four users as members. As shown in FIG. 1, in a group that includes four members, the items preferred by each member, i.e., travel destinations, may differ from each other. In the case of individual recommendation, it is sufficient to recommend the travel destination preferred by each individual member. However, in the case of group recommendation, a travel destination preferred by many members in the group should be recommended, but simply recommending the destination preferred by the most members is not always desirable. For example, even if most members share the same most preferred destination, it may sometimes be more desirable to recommend a destination that all members equally prefer as their second choice, rather than recommending a destination that some members dislike. As such, group recommendation must consider both the relationships between groups and items and the complex mutual relationships between users and items.

In conventional group recommendation, in order to consider interactions for both users and groups together, hypergraph-based methods or self-supervised learning (SSL)-based methods were used. However, these required complex modeling or high training costs, causing a problem in that they could not reflect the frequently changing preferences of members.

### SUMMARY

### Technical Problem

An object of the disclosed embodiments is to provide a group recommendation method and apparatus capable of quickly providing precisely customized recommendations for the entire group by considering not only the group but also the preferences of the members constituting the group.

### Solution to Problem

A group recommendation method according to an embodiment includes: obtaining a member-item matrix representing relationships between users and items, a group-item matrix representing relationships between groups and items, and a member-group matrix representing memberships of users in groups; combining the member-group matrix with the member-item matrix and the group-item matrix, respectively, to obtain an augmented member-item matrix and an augmented group-item matrix, and integrating the member-item matrix and the group-item matrix to obtain a unified matrix; obtaining three similarity matrices representing the similarity between items associated with users, the similarity between items associated with groups, and the similarity between items jointly associated with members and groups, from the augmented member-item matrix, the augmented group-item matrix, and the unified matrix; and setting three polynomial matrix filters for the three similarity matrices, and filtering a row vector corresponding to the item recommendation target group in the group-item matrix with a final polynomial matrix filter composed of the three polynomial matrix filters, to obtain a predicted score vector.

In the step of obtaining the similarity matrices, the three similarity matrices may be obtained by multiplying the augmented member-item matrix, the augmented group-item matrix, and the unified matrix each by their respective transpose matrices.

In the step of obtaining the similarity matrices, the augmented member-item matrix, the augmented group-item matrix, and the unified matrix are each symmetrically normalized so that the mutual influence between nodes of different natures becomes equal in magnitude, thereby obtaining a normalized member matrix, a normalized group matrix, and a normalized unified matrix, and the three similarity matrices are obtained based on these normalized matrices.

In the step of obtaining the predicted score vector, the three polynomial matrix filters may be set by searching for the maximum order and the coefficients for each order of each similarity matrix so that each of the three similarity matrices has the required low-pass filtering characteristics.

In the step of obtaining the predicted score vector, when a row vector corresponding to the item recommendation target group in the group-item matrix is selected, the predicted score vector is obtained by multiplying the selected row vector by the final polynomial matrix filter; and the item corresponding to the element having the largest element value in the predicted score vector is searched for and obtained as a group recommendation item.

A group recommendation apparatus according to an embodiment is an apparatus that includes a memory and a processor that executes at least part of operations according to a program stored in the memory, wherein the processor: obtains a member-item matrix representing relationships between users and items, a group-item matrix representing relationships between groups and items, and a member-group matrix representing memberships of users in groups; combines the member-group matrix with the member-item matrix and the group-item matrix, respectively, to obtain an augmented member-item matrix and an augmented group-item matrix, and integrates the member-item matrix and the group-item matrix to obtain a unified matrix; obtains three similarity matrices representing the similarity between items associated with users, the similarity between items associated with groups, and the similarity between items jointly associated with members and groups, from the augmented member-item matrix, the augmented group-item matrix, and the unified matrix; and sets three polynomial matrix filters for the three similarity matrices, and filters a row vector corresponding to the item recommendation target group in the group-item matrix with a final polynomial matrix filter composed of the three polynomial matrix filters, to obtain a predicted score vector.

### Advantageous Effects of Invention

Therefore, the group recommendation method and apparatus according to the embodiment can quickly and accurately provide customized recommendations for the entire group by considering not only the group but also the preferences of the members constituting the group.

### BRIEF DESCRIPTION OF DRAWINGS

FIG. 1 is a diagram for explaining the concept of group recommendation.

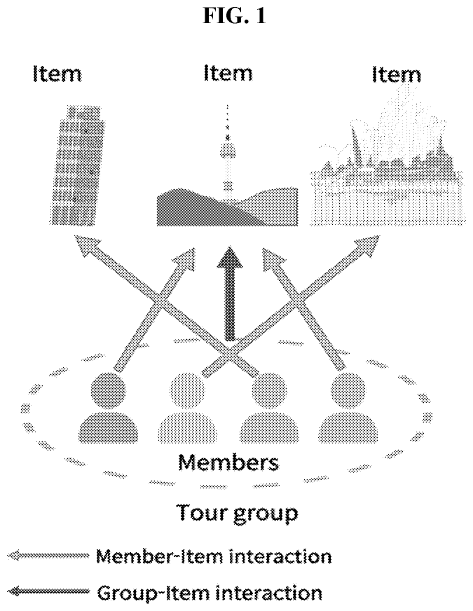

FIG. 2 is a diagram for explaining the concept of graph filtering.

FIG. 3 is a diagram for explaining the operation of fast graph filtering using a polynomial matrix filter.

FIG. 4 illustrates the configuration of the group recommendation apparatus according to an embodiment, divided by operation.

FIG. 5 is a diagram for explaining an operation method of the group recommendation apparatus of FIG. 4.

FIG. 6 illustrates a group recommendation method according to an embodiment.

FIG. 7 is a diagram for explaining a computing environment including a computing device according to an embodiment.

### DESCRIPTION OF EMBODIMENTS

Hereinafter, specific embodiments according to the present disclosure will be described with reference to the drawings. The following detailed description is provided to assist in a comprehensive understanding of the methods, apparatuses, and/or systems described herein. However, this is merely an example, and the present invention is not limited thereto.

In describing the embodiments of the present disclosure, if it is determined that a detailed description of known technology related to the present invention may unnecessarily obscure the gist of the embodiment, the detailed description will be omitted. The terms described below are defined in consideration of their functions in the present invention, and may vary according to the intention or custom of users and operators. Therefore, the definitions should be made based on the content throughout this specification. The terms used in the detailed description are only for describing one embodiment and should never be limiting. Unless clearly used otherwise, singular expressions include plural meanings. In this description, expressions such as “comprising” or “including” are intended to indicate certain characteristics, numbers, steps, operations, elements, or combinations thereof, and should not be interpreted to exclude the existence or possibility of one or more other characteristics, numbers, steps, operations, elements, or combinations thereof. Also, terms such as “ . . . unit”, . . . device”, “module”, and “block” described in the specification mean a unit that processes at least one function or operation, and may be implemented by hardware, software, or a combination of hardware and software.

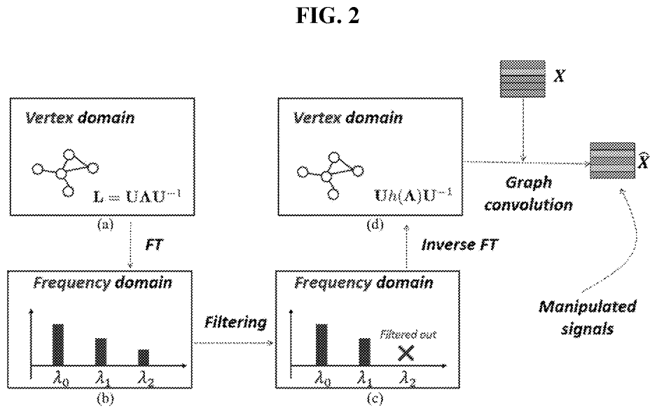

FIG. 2 is a diagram for explaining the concept of graph filtering.

The above hypergraph-based methods and graph neural network-based techniques require very complex modeling or neural network operations, and in particular, neural network-based techniques require prior training, making fast recommendation impossible. Graph Filtering (GF)-based collaborative filtering methods emerged to overcome these limitations. Graph filtering-based collaborative filtering recognizes the strength of edges connected to each node of a graph similarly to signals in a communication system, and by filtering to adjust the strength of edges, i.e., the connection relationships between nodes, efficiently obtains items to recommend to users. Graph filtering-based collaborative filtering methods basically apply a low-pass filter (LPF) to the graph so that the relationships between users and items are smoothly interrelated, thereby enabling item recommendation without using neural networks that require training.

Given a weighted graph (G=(V, E)) consisting of a node set (V) and an edge set (E), the graph Laplacian matrix (L) for the graph (G) can be expressed as the difference (L=D−A) between the degree matrix (D) and the adjacency matrix (A). The adjacency matrix (A) is a symmetric matrix representing the connection relationships (i.e., edges) between different nodes in the graph, and the degree matrix (D) is a diagonal matrix having the number of edges connecting each node to other nodes as diagonal elements and 0 elsewhere, which can be expressed as D=diag(A·1). Here, 1 represents a |V|-dimensional vector whose all elements are 1. Therefore, the graph Laplacian matrix (L) may be composed of a symmetric matrix in which all elements other than the diagonal elements according to the degree matrix (D) have values of 0 or negative.

The graph expressed by the graph Laplacian matrix (L) can be decomposed as L=UAU⁻¹ by eigen-decomposition that analyzes eigenvalues and eigenvectors, as shown in FIG. 2(a). Here, A is an eigenvalue matrix (A=Diag(λ₁, λ₂, . . . , λ_{|V|})) having the eigenvalues (λ₁, λ₂, . . . , λ_{|V|}) for each of the |V| nodes included in the node set (V) as diagonal elements, U is an eigenvector matrix having columns corresponding to the set of eigenvectors of the graph Laplacian matrix (L), and U⁻¹ is the inverse matrix of the eigenvector matrix (U).

Meanwhile, the graph signal (x) obtained by converting the graph (G) into a signal can be expressed in the |V|-dimensional vector format (x=[x₁, x₂, . . . , x_{|V|}]^{T}) consisting of the signal strengths between the |V| nodes in the node set (V). From the fact that the graph Laplacian matrix (L) is eigen-decomposed into the eigenvalue matrix (A) and the eigenvector matrix (U), the Fourier Transform (FT) of the graph signal (x) can be defined as \hat{x}=U^{T}x. Here, U^{T} is the transpose matrix of the eigenvector matrix (U). That is, the eigen-decomposition of the graph Laplacian matrix (L) can be viewed as an operation analogous to the Fourier transform of the graph signal (x), as shown in FIG. 2(b).

The graph filter (H(L)) applied to the graph Laplacian matrix (L) can be defined as Equation 1.

H(L)=Udiag(h(λ₁), . . . ,h(λ_{|V|}))U^{T} [Equation 1]

Here, h denotes the frequency response function that maps the eigenvalues ({λ₁, λ₂, . . . , λ_{|V|}}) of the graph Laplacian matrix (L) to {h(λ₁), h(λ₂), . . . , h(λ_{|V|})}.

Graph filtering can be performed as the convolution of the graph signal (x) and the graph filter (H(L)), and thus can be defined as Equation 2.

H(L)x=Udiag(h(λ₁), . . . ,h(λ_{|V|}))U^{T}x [Equation 2]

The smoothness (S(x)) of the graph signal (x) with respect to the graph (G) can be quantified as S(x)=Σ_{i,j}A_{i,j}(xᵢ−xⱼ)²=x^{T} Lx. Here, A_{i,j} denotes the (i,j)-th element of the adjacency matrix (A), and xᵢ denotes the signal strength of the i-th node in the graph signal (x). Therefore, the smaller the smoothness (S(x)), the smoother the graph signal (x) becomes.

As described above, in graph filtering-based collaborative filtering, a low-pass filter is mainly used, which can be viewed as an operation that retains only some of the eigenvalues ({λ₁, λ₂, . . . , λ_{|V|}}) of the graph Laplacian matrix (L) and removes high-order eigenvalues by filtering, as shown in FIG. 2(c). Therefore, as shown in FIG. 2(d), by setting the filtering function (h(Λ)) applied to the eigenvalue matrix (Λ={λ₁, λ₂, . . . , λ_{|V|}}) of the eigen-decomposed graph Laplacian matrix (L) so as to derive a frequency response in which high-order eigenvalues are removed, and then applying U·h(Λ)·U⁻¹, low-pass filtering can be performed on the graph (G).

However, in graph filtering-based collaborative filtering, the graph filter (H(L)) is set to be an ideal low-pass filter, and this process requires high computational cost for matrix decomposition. To reduce this high computational cost, fast graph filtering has been proposed, which constructs a polynomial low-pass filter (Polynomial LPF) having a polynomial matrix form and performs filtering without using matrix decomposition.

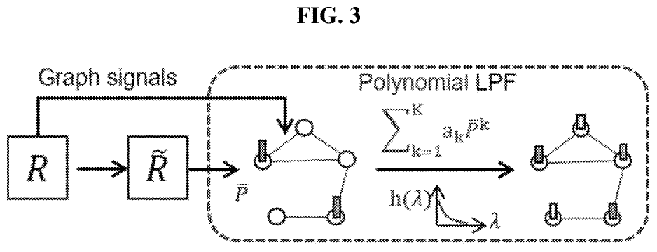

FIG. 3 is a diagram for explaining the operation of fast graph filtering using a polynomial matrix filter.

In FIG. 3, fast graph filtering performs polynomial matrix filtering on a matrix (R) obtained from a graph. Here, the matrix (R) may be a matrix having the values of edges connecting nodes as elements according to the relationships between multiple nodes in the graph. As an example, in a recommendation system, the matrix (R) may be a rating matrix representing users' preferences for items or a matrix indicating whether items have been used. And \tilde{R} denotes the normalized matrix obtained by normalizing the matrix (R).

Referring to FIG. 3, in the case of general graph filtering, the matrix (R) is eigenvalue-decomposed to obtain eigenvalues ({λ₁, λ₂, . . . , λ_{|V|}}), and the frequency response function (h(λ)) for each eigenvalue is found so that only some of the obtained eigenvalues remain. Then, the found frequency response function (h(λ)) for each eigenvalue is applied to the graph signal according to the matrix (R) to perform low-pass filtering. That is, a filtering function (h(Λ)) composed of the frequency response functions (h(λ)) found for each eigenvalue of the matrix (R) is obtained to perform low-pass filtering. In this process, eigenvalue decomposition of the matrix (R) must be performed first.

However, in the fast graph filtering technique using polynomial matrix filters, a similarity matrix (P̅) is obtained from the matrix (R), and based on the obtained similarity matrix (P̅), a polynomial matrix filter

$$( f ( \overline{P} ) = {\sum }_{k = 1}^{K} {a}_{k} {\overline{P}}^{k} )$$

for filtering the matrix (R) is obtained. Then, by applying the obtained matrix filter (f(P̅_{f})) to the matrix (R), low-pass filtering can be performed. Therefore, graph filtering can be performed without performing eigenvalue decomposition on the matrix (R). Since this is a known technique, it will not be described in detail here.

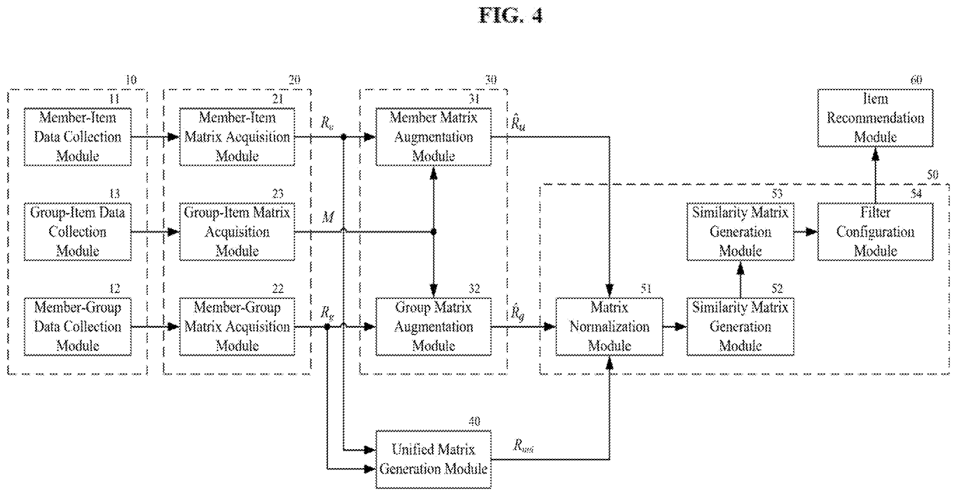

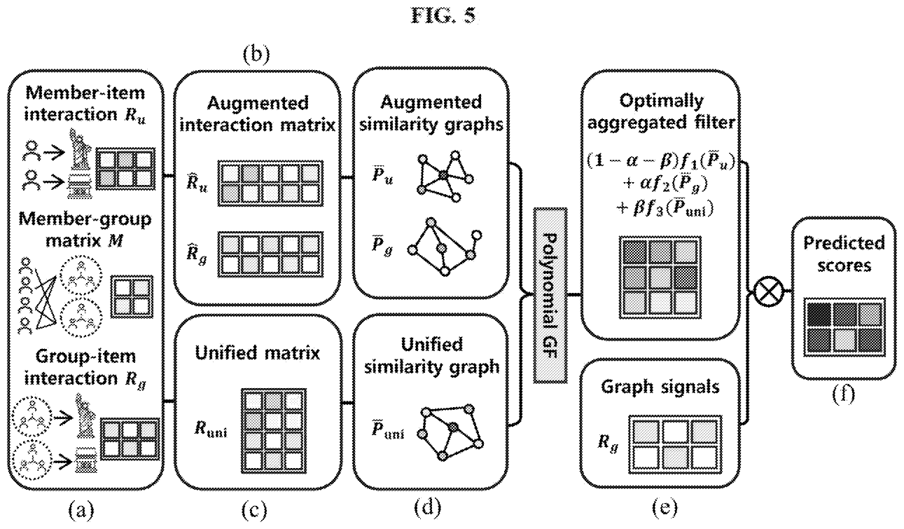

FIG. 4 illustrates the configuration of the group recommendation apparatus divided by operation, and FIG. 5 illustrates the operation method of the apparatus of FIG. 4.

Referring to FIG. 4, the group recommendation apparatus according to one embodiment may include a data collection module 10, a matrix generation module 20, an augmentation module 30, a unified matrix generation module 40, a filter generation module 50, and an item recommendation module 60.

The data collection module 10 collects data representing the interactions between multiple members in the member set (U={u₁, u₂, . . . , u_{|U|}}), multiple groups in the group set (G={g₁, g₂, . . . , g_{|G|}}), and multiple items in the item set (I={i₁, i₂, . . . , i_{|I|}}). The data collection module 10 may include a member-item data collection module 11 that collects member-item data representing the association between users and items, a group-item data collection module 12 that collects group-item data representing the association between groups and items, and a member-group data collection module 13 that collects member-group data representing the association between users and groups. For example, member-item data may consist of whether each of multiple users has used each of multiple items or the ratings they have given, group-item data may consist of whether each of multiple groups has used each items, or rating assigned thereto, and member-group data may consist of whether multiple users are included in multiple groups. Here, although the data collection module 10 has been described as collecting member-item data, group-item data, and member-group data separately, each data may also be collected in graph form. That is, member-item data, group-item data, and member-group data may each be obtained as a member-item graph, a group-item graph, and a member-group graph, respectively.

The matrix generation module 20, as shown in FIG. 5(a), generates a member-item matrix Rᵤ, a group-item matrix R_{g}, and a member-group matrix M using the member-item data, group-item data, and member-group data obtained from the data collection module 10. The matrix generation module 20 may include a member-item matrix acquisition module 21, a group-item matrix acquisition module 22, and a member-group matrix acquisition module 23. Here, the member-item matrix Rᵤ and the group-item matrix R_{g} are matrices of size [symbol] and [symbol] , respectively, having ratings as element values or 1 if usage history exists. The member-group matrix M is a matrix of size [symbol] , having element value 1 if the user is a member of the group and 0 otherwise.

Here, the data collection module 10 and matrix generation module 20 are configured separately for clarity, but may be integrated into a single graph matrix acquisition module.

The augmentation module 30, as shown in FIG. 5(b), augments the member-item matrix Rᵤ and the group-item matrix R_{g} each with the member-group matrix M to obtain the augmented member-item matrix \hat{R}ᵤ and the augmented group-item matrix \hat{R}_{g}. The augmentation module 30 may include a member matrix augmentation module 31 and a group matrix augmentation module 32. The member matrix augmentation module 31 receives the member-item matrix Rᵤ of size [symbol] and the member-group matrix M of size [symbol] , and obtains the augmented member-item matrix [symbol] as \hat{R}ᵤ=Rᵤ∥M^{T} (where ∥ denotes concatenation) by concatenating Rᵤ with the transpose M^{T}. The group matrix augmentation module 32 receives the group-item matrix R_{g} of size [symbol] and the member-group matrix M of size [symbol] , and obtains the augmented group-item matrix [symbol] as \hat{R}_{g}=R_{g}∥M by combining R_{g} with M.

The augmentation module 30 combines the member-group matrix M representing the relationships between members and groups with each of the member-item matrix Rᵤ and the group-item matrix R_{g}, thereby supplementing Rᵤ with group information and the group-item matrix R_{g} with member information, so that the interrelationships among members, groups, and items are reflected at the time of item recommendation.

Meanwhile, as shown in FIG. 5(c), the unified matrix generation module 40 receives the member-item matrix Rᵤ of size [symbol] and the group-item matrix R_{g} of size [symbol] , and integrates them into a single matrix by stacking them vertically (row-wise) as in Equation 3 to form the unified matrix Rᵤₙᵢ of size [symbol] .

$${R}_{uni} = [ \begin{matrix}{R}_{g} \\ {R}_{u}\end{matrix} ] \qquad [ Equation 3 ]$$

The unified matrix Rᵤₙᵢ can be viewed as a matrix representing item associations by treating multiple members and groups equally.

The filter generation module 50 receives the augmented member-item matrix \hat{R}ᵤ, the augmented group-item matrix \hat{R}_{g}, and the unified matrix Rᵤₙᵢ, and generates the polynomial matrix filters f(P̅_{f}) for performing fast graph filtering. At this time, the filter generation module 50 may generate individual polynomial matrix filters f₁(P̅ᵤ), f₂(P̅_{g}), f₃(P̅ᵤₙᵢ) for the augmented member-item matrix \hat{R}ᵤ, the augmented group-item matrix \hat{R}_{g}, and the unified matrix Rᵤₙᵢ, respectively.

The filter generation module 50 may include a matrix normalization module 51, a similarity matrix generation module 52, a smoothness adjustment module 53, and a filter configuration module 54.

The matrix normalization module 51 receives the augmented member-item matrix \hat{R}ᵤ, the augmented group-item matrix \hat{R}_{g}, and the unified matrix Rᵤₙᵢ, and normalizes each according to Equation 4 to obtain the normalized member matrix \hat{R}ᵤ, the normalized group matrix \hat{R}_{g}, and the normalized unified matrix \hat{R}ᵤₙᵢ.

$${\tilde{R}}_{u} = {D}_{𝒰}^{- 0.5} {\hat{R}}_{u} {D}_{{ℐ}_{u}}^{- 0.5} ; \qquad [ Equation 4 ]$$

$${\tilde{R}}_{g} = {D}_{𝒢}^{- 0.5} {\hat{R}}_{g} {D}_{{ℐ}_{g}}^{- 0.5} ;$$

$${\tilde{R}}_{g} = {D}_{uni}^{- 0.5} {R}_{uni} {D}_{{ℐ}_{uni}}^{- 0.5}$$

Here, D_{U} and D_{Iu} are the diagonal matrices of the member-group nodes and item nodes in the augmented member-item matrix \hat{R}ᵤ, obtained as Dᵤ=diag (\hat{R}ᵤ1) and D_{Iu}=diag (1^{T}\hat{R}ᵤ), respectively. Here, 1 is a vector consisting of all-one elements. Also, D_{G} and D_{Ig} are the diagonal matrices of the group-member nodes and item nodes in the augmented group-item matrix \hat{R}_{g}, obtained as D_{G}=diag (\hat{R}_{g}1) and D_{Ig}=diag (1^{T}\hat{R}_{g}). In addition, Dᵤₙᵢ and D_{Iuni} are the diagonal matrices of the member-group nodes and item nodes in the unified matrix Rᵤₙᵢ, obtained as Dᵤₙᵢ=diag (Rᵤₙᵢ1)D_{Iuni}=diag (1^{T}Rᵤₙᵢ).

The reason why the matrix normalization module 51 normalizes the augmented member-item matrix \hat{R}ᵤ, the augmented group-item matrix \hat{R}_{g}, and the unified matrix Rᵤₙᵢ is that, unlike the graph Laplacian matrix (L) in which nodes are not distinguished, these matrices—the augmented member-item matrix \hat{R}ᵤ, the augmented group-item matrix \hat{R}_{g} and the unified matrix Rᵤₙᵢ—have nodes of different natures (member-group nodes, group-member nodes, and item nodes), and normalization is performed to equalize the mutual influence between nodes. Here, it is assumed that symmetric normalization with equal mutual influence is performed. The matrix normalization module 51 normalizes the augmented member-item matrix \hat{R}ᵤ, the augmented group-item matrix \hat{R}_{g}, and the unified matrix Rᵤₙᵢ as

$${D}_{𝒰}^{- 0.5} and {D}_{{ℐ}_{u}}^{- 0.5} , {D}_{𝒢}^{- 0.5} and {D}_{{ℐ}_{g}}^{- 0.5} , and {D}_{uni}^{- 0.5} and {D}_{{ℐ}_{uni}}^{- 0.5} ,$$

respectively. However, in some cases, normalization may not be performed, in which case the matrix normalization module 51 may be omitted.

The similarity matrix generation module 52 receives the normalized member matrix \tilde{R}ᵤ, the normalized group matrix \tilde{R}_{g}, and the normalized unified matrix \tilde{R}ᵤₙᵢ, and obtains the member similarity matrix \tilde{P}ᵤ, the group similarity matrix \tilde{P}_{g}, and the unified similarity matrix \tilde{P}ᵤₙᵢ.

As in Equation 5, the similarity matrix generation module 52 multiplies the normalized member matrix \tilde{R}ᵤ, the normalized group matrix \tilde{R}_{g}, and the normalized unified matrix \tilde{R}ᵤₙᵢ by their respective transpose matrices

$${\tilde{R}}_{u}^{⊤} , {\tilde{R}}_{g}^{⊤} , {\tilde{R}}_{uni}^{⊤}$$

to obtain the member similarity matrix \tilde{P}ᵤ, the group similarity matrix \tilde{P}_{g}, and the unified similarity matrix \tilde{P}ᵤₙᵢ.

$${\tilde{P}}_{u} = {\tilde{R}}_{u}^{⊤} {\tilde{R}}_{u} ; \qquad [ Equation 5 ]$$

$${\tilde{P}}_{g} = {\tilde{R}}_{g}^{⊤} {\tilde{R}}_{g} ;$$

$${\tilde{P}}_{u n i} = {\tilde{R}}_{uni}^{⊤} {\tilde{R}}_{u n i}$$

Here, the member similarity matrix \tilde{P}ᵤ has a size of [symbol] , the group similarity matrix \tilde{P}_{g} has a size of [symbol] , and the unified similarity matrix \tilde{P}ᵤₙᵢ has a size of [symbol] .

The smoothness adjustment module 53 adjusts the smoothness of the member similarity matrix \tilde{P}ᵤ, the group similarity matrix \tilde{P}_{g}, and the unified similarity matrix \tilde{P}ᵤₙᵢ, respectively. The smoothness adjustment module 53 adjusts the weights of edges connecting nodes in the similarity graphs of each similarity matrix \tilde{P}ᵤ, \tilde{P}_{g}, \tilde{P}ᵤₙᵢ to obtain the adjusted member similarity matrix \tilde{P}ᵤ, the adjusted group similarity matrix \tilde{P}_{g}, and the adjusted unified similarity matrix \tilde{P}ᵤₙᵢ. When filtering is performed based on a low-pass filter graph filtering technique, the filtered similarity matrix may be over-smoothed or under-smoothed. In this case, the similarity strengths between items in the filtered matrices may become similar in magnitude, making it difficult to recommend suitable items for the group. To address this, the smoothness adjustment module 53 pre-adjusts the element values of the similarity matrices \tilde{P}ᵤ, \tilde{P}_{g}, \tilde{P}ᵤₙᵢ before filtering so that the similarities remain distinct even after filtering. The adjusted similarity matrices \tilde{P}ᵤ, \tilde{P}_{g}, \tilde{P}ᵤₙᵢ can be easily converted into similarity graphs as shown in FIG. 5(d).

The smoothness adjustment module 53 obtains the adjusted similarity matrices according to Equation 6 so that the weights of the edges connecting items in the member similarity matrix \tilde{P}ᵤ, the group similarity matrix \tilde{P}_{g}, and the unified similarity matrix \tilde{P}ᵤₙᵢ are each adjusted differently by applying a Hadamard power to each similarity matrix \tilde{P}ᵤ, \tilde{P}_{g}, \tilde{P}ᵤₙᵢ to obtain the adjusted similarity matrices \tilde{P}ᵤ, \tilde{P}_{g}, \tilde{P}ᵤₙᵢ.

$${\overline{P}}_{u} = {\tilde{P}}_{u}^{∘ {s}_{1}} ; \qquad [ Equation 6 ]$$

$${\overline{P}}_{g} = {\tilde{P}}_{g}^{∘ {s}_{2}} ;$$

$${\overline{P}}_{uni} = {\tilde{P}}_{uni}^{∘ {s}_{3}} ;$$

Here, ∘ is the Hadamard power operator, and s₁, s₂, s₃ are adjustment parameters.

That is, the adjusted similarity matrices P̅ᵤ, P̅_{g}, P̅ᵤₙᵢ can be obtained by raising each element of the similarity matrices \tilde{P}ᵤ, \tilde{P}_{g}, \tilde{P}ᵤₙᵢ to the power of the adjustment parameters (s₁, s₂, s₃). Here, the adjustment parameters (s₁, s₂, s₃) may be set based on the element distribution of the similarity matrices \tilde{P}ᵤ, \tilde{P}_{g}, \tilde{P}ᵤₙᵢ, but the adjustment parameters (s₁, s₂, s₃) may also be set differently from each other according to the polynomial matrix filters f₁(P̅ᵤ), f₂(P̅_{g}), f₃(P̅ᵤₙᵢ) set by the filter configuration module 54. When the polynomial matrix filters f₁(P̅ᵤ), f₂(P̅_{g}), f₃(P̅ᵤₙᵢ) are configured, the adjustment parameters according to the configurable polynomial matrix filters f₁(P̅ᵤ), f₂(P̅_{g}), f₃(P̅ᵤₙᵢ) may be pre-specified.

The filter configuration module 54 receives the adjusted member similarity matrix P̅ᵤ, the adjusted group similarity matrix P̅_{g}, and the adjusted unified similarity matrix P̅ᵤₙᵢ, and searches for and sets polynomial matrix filters for each of the received adjusted similarity matrices P̅ᵤ, P̅_{g}, P̅ᵤₙᵢ, setting the member polynomial matrix filter f₁(P̅ᵤ), the group polynomial matrix filter f₂(P̅_{g}), and the unified polynomial matrix filter f₃(P̅ᵤₙᵢ).

Here, the filter configuration module 54 can search for and set the polynomial matrix P̅ᵤ, P̅_{g}, P̅ᵤₙᵢ suitable for the adjusted similarity matrices f₁(P̅ᵤ), f₂(P̅_{g}), f₃(P̅ᵤₙᵢ). In filters this case, the polynomial matrix filters for all adjusted similarity matrices P̅ᵤ, P̅_{g}, P̅ᵤₙᵢ may be set the same as the polynomial matrix filters f₁(P̅ᵤ), f₂(P̅_{g}), f₃(P̅ᵤₙᵢ). However, since the eigenvalue distributions of each adjusted similarity matrix P̅ᵤ, P̅_{g}, P̅ᵤₙᵢ generally differ significantly, the polynomial matrix filters f₁(P̅ᵤ), f₂(P̅_{g}), f₃(P̅ᵤₙᵢ) are typically set differently from each other.

As described in FIG. 3, in the fast graph filtering technique using polynomial matrix filters, a similarity matrix P̅ is obtained, and based on the obtained similarity matrix P̅, a polynomial matrix filter f(P̅) for filtering the matrix (R) is set.

The graph Laplacian matrix (L) for the similarity matrix P̅ can be expressed as L=I−P̅. The graph Laplacian matrix (L) for the similarity matrix P̅ can be orthogonally eigen-decomposed (L=UΛU^{T}). Here, I is a matrix satisfying I=UU^{T}=U^{T}U.

Since the graph Laplacian matrix (L) is orthogonally eigen-decomposed (L=UΛU^{T}) based on the orthogonal matrix (U), the eigenvalues ({λ₁, λ₂, . . . , λ_{|V|}}) of the graph Laplacian matrix (L) can be manipulated in the form of polynomials of the graph Laplacian matrix (L) (e.g., L²=UΛ²U^{T}) without performing matrix decomposition that requires high computational cost. That is, by manipulating the eigenvalues ({λ₁, λ₂, . . . , λ_{|V|}}) of the graph Laplacian matrix (L) without performing matrix decomposition so that the frequency response has a low-pass filtered form, a low-pass filter can be set.

The filter configuration module 54 can set the polynomial matrix filter f(P̅) for low-pass filtering the matrix (R) based on the similarity matrix P according to Equation 7.

$$f ( \overline{P} ) = {\sum }_{k = 1}^{K} {a}_{k} {\overline{P}}^{k} \qquad [ Equation 7 ]$$

Here, aₖ denotes the coefficient for each order (k), and K denotes the maximum order of the polynomial matrix filter.

The frequency response function (h(λ)) for the polynomial matrix filter f(P̅) of Equation 7 is expressed as Equation 8.

$$h ( λ ) = {\sum }_{k = 1}^{K} {{a}_{k} ( 1 - λ )}^{k} \qquad [ Equation 8 ]$$

The filter configuration module 54 searches for the maximum order (K) and per-order coefficients (aₖ) that enable the frequency response function (h(λ)) for the similarity matrix P̅ to have the required low-pass filtering characteristics, and sets the polynomial matrix filter f(P̅). For example, if h(λ)=1−λ² is required, the maximum order K=2, the 1st-order coefficient a₁=2, and the 2nd-order coefficient a₂=−1, so the polynomial matrix filter f(P̅) can be set as f(P̅)=2P̅−P̅². If h(λ)=1−λ (linear form), K=1 and a₁=1, so the polynomial matrix filter f(P̅) can be set as f(P̅)=P̅.

In this manner, the filter configuration module 54 searches for the maximum orders and per-order coefficients for each adjusted similarity matrix P̅ᵤ, P̅_{g}, P̅ᵤₙᵢ such that the frequency response functions (h₁(λ), h₂(λ), h₃(λ)) of the polynomial matrix filters f₁(P̅ᵤ), f₂(P̅_{g}), f₃ (P̅ᵤₙᵢ) have the required low-pass filtering characteristics, and sets the polynomial matrix filters f₁(P̅ᵤ), f₂(P̅_{g}), f₃(P̅ᵤₙᵢ) in the format of Equation 9.

$${f}_{1} ( {\overline{P}}_{u} ) = {\sum }_{k = 1}^{{K}_{u}} {a}_{k} {\overline{P}}_{u}^{k} ; \qquad [ Equation 9 ]$$

$${f}_{2} ( {\overline{P}}_{g} ) = {\sum }_{k = 1}^{{K}_{g}} {b}_{k} {\overline{P}}_{g}^{k} ;$$

$${f}_{3} ( {\overline{P}}_{uni} ) = {\sum }_{k = 1}^{{K}_{uni}} {c}_{k} {\overline{P}}_{uni}^{k} ;$$

Here, aₖ, bₖ, and cₖ are the coefficients for each order (k), and Kᵤ, K_{g}, and Kᵤₙᵢ denote the maximum order of each polynomial matrix filter.

In some cases, multiple polynomial matrix filters f(P̅) may be pre-specified, and the filter configuration module 54 may select and set the polynomial matrix filter f(P̅) most suitable for the required low-pass filtering characteristics from among the pre-specified filters f(P̅). When the filter configuration module 54 is configured to select and set from pre-specified polynomial matrix filters f(P̅), the need to search for maximum orders (Kᵤ, K_{g}, Kᵤₙᵢ) and per-order coefficients (aₖ, bₖ, cₖ) is reduced, enabling faster group item recommendation. In this case, the designated polynomial matrix filter f(P̅) and the adjustment parameters (s₁, s₂, s₃) may also be pre-matched and set. That is, when the polynomial matrix filters P̅ᵤ, P̅_{g}, P̅ᵤₙᵢ for each adjusted similarity matrix f₁(P̅ᵤ), f₂(P̅_{g}), f₃(P̅ᵤₙᵢ) are selected, the adjustment parameters (s₁, s₂, s₃) pre-matched to each selected polynomial matrix filter are also selected together, so that each adjusted similarity matrix P̅ᵤ, P̅_{g}, P̅ᵤₙᵢ can be obtained.

The item recommendation module 60 receives the member polynomial matrix filter f₁(P̅ᵤ), the group polynomial matrix filter f₂(P̅_{g}), and the unified polynomial matrix filter f₃(P̅ᵤₙᵢ) set by the filter configuration module 54, and obtains the final polynomial matrix filter f(P̅ᵤ; P̅_{g}; P̅ᵤₙᵢ) according to Equation 10.

f(P̅ᵤ;P̅_{g};P̅ᵤₙᵢ)=(1−α−β)f₁(P̅ᵤ)+αf₂(P̅_{g})+βf₃(P̅ᵤₙᵢ) [Equation 10]

Here, α and β are hyperparameters for adjusting the balance among the three polynomial matrix filters f₁(P̅ᵤ), f₂(P̅_{g}), f₃(P̅ᵤₙᵢ).

Once the final polynomial matrix filter f(P̅ᵤ; P̅_{g}; P̅ᵤₙᵢ) is obtained, the item recommendation module 60 obtains the predicted score vector s_{g} for each item for the recommendation target group g according to Equation 11.

s_{g}=r_{g}((1−α−β)f₁(P̅ᵤ)+αf₂(P̅_{g})+βf₃(P̅ᵤₙᵢ)) [Equation 11]

Here, r_{g} is the g-th row vector of the group-item matrix R_{g}, which is the graph signal for the g-th group, and s_{g} is a vector consisting of the predicted scores for each item for the g-th group.

The item recommendation module 60, as shown in FIG. 5(f), once the member polynomial matrix filter f₁(\hat{P}ᵤ), the group polynomial matrix filter f₂(P̅_{g}), and the unified polynomial matrix filter f₃(P̅ᵤₙᵢ) are set, obtains the final polynomial matrix filter based on these three polynomial matrix filters according to Equation 10, applies it to the graph signal r_{g}, and obtains the predicted score vector s_{g}.

The predicted score vector s_{g} is a vector consisting of the predicted preference scores for each item in the item set (I) of the recommendation target group g. Accordingly, the item recommendation module 60 recommends the item with the highest predicted score in s_{g} to the recommendation target group g.

As such, the group recommendation apparatus according to one embodiment recommends items to the group by considering not only the item preferences of the group but also the item preferences of each individual member along with the relationships between the group and the members included in the group, thereby enabling highly reliable item recommendation. Furthermore, since it applies a training-free graph filtering technique that does not require eigenvalue decomposition of matrices, it can recommend group items very quickly even when there are changes in users, groups, or items.

In the illustrated embodiment, each component may have different functions and capabilities other than those described above, and may include additional components not described. Also, in one embodiment, each component may be implemented using one or more physically separate devices, or by one or more processors or a combination of one or more processors and software, and the specific operations may not be clearly distinguished unlike the illustrated example.

The group recommendation apparatus shown in FIG. 4 may be implemented in a logic circuit by hardware, firmware, software, or a combination thereof, and may also be implemented using a general-purpose or special-purpose computer. The apparatus may be a hardwired device, a Field Programmable Gate Array (FPGA), an Application Specific Integrated Circuit (ASIC), or may be implemented as a System on Chip (SoC) comprising one or more processors and controllers.

In addition, the group recommendation apparatus may be installed on a computing device or server equipped with hardware elements in the form of software, hardware, or a combination thereof. The computing device or server may refer to a variety of devices comprising all or some of: communication devices such as a communication modem for communicating with various devices or wired/wireless communication networks, memory for storing data for executing programs, and a microprocessor or the like for computing and instructing to execute programs.

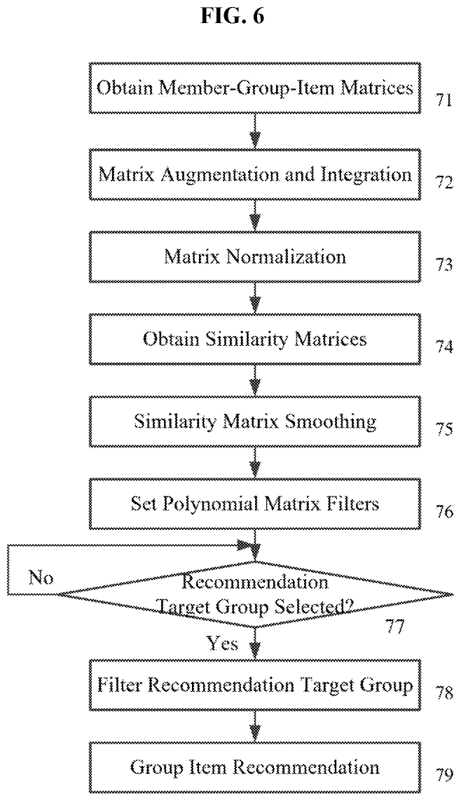

FIG. 6 illustrates a group recommendation method according to an embodiment.

Referring to FIG. 6, the group recommendation method according to one embodiment first obtains a member-item matrix Rᵤ, a group-item matrix R_{g}, and a member-group matrix M from the collected member-item data, group-item data, and member-group data, respectively in step 71. Then, Rᵤ and the group-item matrix R_{g} are each augmented with M to obtain the augmented member-item matrix \hat{R}ᵤ and the augmented group-item matrix \hat{R}_{g}, and the member-item matrix Rᵤ and the group-item matrix R_{g} are integrated to obtain the unified matrix Rᵤₙᵢ in step 72.

Once the augmented member-item matrix \hat{R}ᵤ, the augmented group-item matrix \hat{R}_{g} and the unified matrix Rᵤₙᵢ are obtained, the augmented member-item matrix \hat{R}ᵤ, the augmented group-item matrix \hat{R}_{g}, and the unified matrix Rᵤₙᵢ are each normalized in the specified manner of Equation 4 to obtain the normalized member matrix \tilde{R}ᵤ, the normalized group matrix \tilde{R}_{g}, and the normalized unified matrix Rᵤₙᵢ in step 73. In some cases, the normalization step may be omitted.

Then, the normalized member matrix \tilde{R}ᵤ, the normalized group matrix \tilde{R}_{g}, and the normalized unified matrix Rᵤₙᵢ are each matrix-multiplied by their respective transpose matrices

$${\tilde{R}}_{u}^{⊤} , {\tilde{R}}_{g}^{⊤} , {\tilde{R}}_{uni}^{⊤}$$

to obtain the member similarity matrix \tilde{P}ᵤ, the group similarity matrix \tilde{P}_{g}, and the unified similarity matrix \tilde{P}ᵤₙᵢ in step 74. If the normalization step was omitted, the augmented member-item matrix \hat{R}ᵤ, the augmented group-item matrix \hat{R}_{g}, and the unified matrix Rᵤₙᵢ are each multiplied by their transpose matrices to obtain \tilde{P}ᵤ, \tilde{P}_{g}, and \tilde{P}ᵤₙᵢ.

Then, the elements of the member similarity matrix \tilde{P}ᵤ, the group similarity matrix \tilde{P}_{g}, and the unified similarity matrix \tilde{P}ᵤₙᵢ are raised to the power of the adjustment parameters (s₁, s₂, s₃) by applying the Hadamard power to obtain the adjusted member similarity matrix P̅ᵤ, the adjusted group similarity matrix P̅_{g}, and the adjusted unified similarity matrix P̅ᵤₙᵢ in step 75.

Once the adjusted similarity matrices P̅ᵤ, P̅_{g}, P̅ᵤₙᵢ are obtained, the maximum orders and per-order coefficients for each adjusted similarity matrix P̅ᵤ, P̅_{g}, P̅ᵤₙᵢ are searched so that the frequency response functions (h₁(λ), h₂(λ), h₃(λ)) of the polynomial matrix filters f₁(P̅ᵤ), f₂(P̅_{g}), f₃(P̅ᵤₙᵢ) have the required low-pass filtering characteristics, and the polynomial matrix filters f₁(P̅ᵤ), f₂(P̅_{g}), f₃(P̅ᵤₙᵢ) in the format of Equation 9 are obtained in step 76. Once the member polynomial matrix filter f₁(P̅ᵤ), the group polynomial matrix filter f₂(P̅_{g}), and the unified polynomial matrix filter f₃(P̅ᵤₙᵢ) are set, the final polynomial matrix filter f(P̅ᵤ; P̅_{g}; P̅ᵤₙᵢ) is obtained based on the set member polynomial matrix filter, group polynomial matrix filter, and unified polynomial matrix filter according to Equation 10.

Once the final polynomial matrix filter f(P̅ᵤ; P̅_{g}; P̅ᵤₙᵢ) is obtained, it is determined whether an item recommendation target group g is selected in step 77. If item recommendation target group g is selected, the row vector r_{g} corresponding to g is extracted from the group-item matrix R_{g}, and r_{g} is filtered with the polynomial matrix filters f₁(P̅ᵤ), f₂(P̅_{g}), f₃(P̅ᵤₙᵢ) as in Equation 11 to obtain the predicted score vector s_{g} in step 78. The item corresponding to the element with the largest value in s_{g} is then searched for and recommended to the group g.

Although FIG. 6 describes each process as being executed sequentially, this is merely illustrative, and those skilled in the art will understand that various modifications and variations are possible, such as changing the order described in FIG. 6, executing one or more processes in parallel, or adding other processes, within the scope not deviating from the essential characteristics of the embodiments of the present invention.

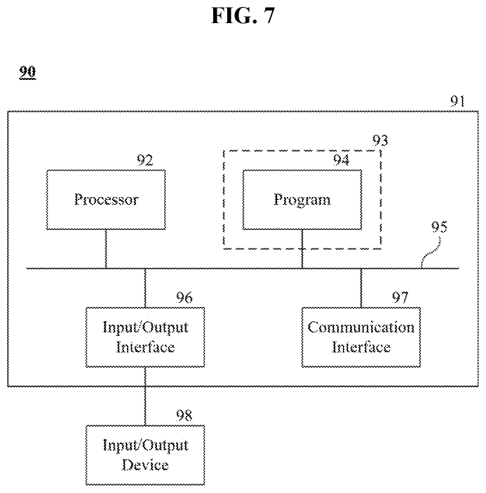

FIG. 7 is a diagram for explaining a computing environment including a computing device according to an embodiment.

In the illustrated embodiment, each component may have different functions and capabilities other than those described below, and may include additional components not described below. The illustrated computing environment 90 includes a computing device 91 and can perform the group recommendation method shown in FIG. 6. In one embodiment, the computing device 91 may be one or more of the components included in the group recommendation apparatus shown in FIG. 4.

The computing device 91 includes at least one processor 92, a computer-readable storage medium 93, and a communication bus 95. The processor 92 may cause the computing device 91 to operate according to the aforementioned exemplary embodiments. For example, the processor 92 may execute one or more programs 94 stored in the computer-readable storage medium 93. The one or more programs 94 may include one or more computer-executable instructions, which when executed by the processor 92, may be configured to cause the computing device 91 to perform operations according to the exemplary embodiments.

The communication bus 95 interconnects the processor 92, the computer-readable storage medium 93, and various other components of the computing device 91.

The computing device 91 may also include one or more input/output interfaces 96 that provide interfaces for one or more input/output devices 98, and one or more communication interfaces 97. The input/output interface 96 and the communication interface 97 are connected to the communication bus 95. The input/output device 98 may be connected to other components of the computing device 91 through the input/output interface 96. Exemplary input/output devices 98 may include input devices such as pointing devices (e.g., a mouse or trackpad), a keyboard, touch input devices (e.g., a touchpad or touchscreen), voice or sound input devices, and various types of sensor devices and/or imaging devices, and/or output devices such as display devices, printers, speakers, and/or network cards. The exemplary input/output device 98 may be included inside the computing device 91 as a component thereof, or may be connected to the computing device 91 as a separate device.

Although the present invention has been described in detail through representative embodiments above, those skilled in the art will understand that various modifications and equivalent other embodiments are possible therefrom. Therefore, the true technical protection scope of the present invention should be determined by the technical spirit of the appended claims.

What is claimed is:

1. A group recommendation method, comprising:
obtaining a member-item matrix representing relationships between users and items, a group-item matrix representing relationships between groups and items, and a member-group matrix representing memberships of users in groups;
combining the member-group matrix with the member-item matrix and the group-item matrix, respectively, to obtain an augmented member-item matrix and an augmented group-item matrix, and integrating the member-item matrix and the group-item matrix to obtain a unified matrix;
obtaining three similarity matrices representing a similarity between items associated with users, a similarity between items associated with groups, and a similarity between items jointly associated with members and groups, from the augmented member-item matrix, the augmented group-item matrix, and the unified matrix; and
setting three polynomial matrix filters for the three similarity matrices, and filtering a row vector corresponding to an item recommendation target group in the group-item matrix with a final polynomial matrix filter composed of the three polynomial matrix filters to obtain a predicted score vector.

2. The group recommendation method of claim 1, wherein the step of obtaining the similarity matrices comprises multiplying the augmented member-item matrix, the augmented group-item matrix, and the unified matrix each by their respective transpose matrices to obtain the three similarity matrices.

3. The group recommendation method of claim 1, wherein the step of obtaining the similarity matrices comprises symmetrically normalizing each of the augmented member-item matrix, the augmented group-item matrix, and the unified matrix so that mutual influence between nodes of different natures becomes equal in magnitude, thereby obtaining a normalized member matrix, a normalized group matrix, and a normalized unified matrix, and obtaining the three similarity matrices based on the normalized member matrix, the normalized group matrix, and the normalized unified matrix.

4. The group recommendation method of claim 1, wherein the step of obtaining the predicted score vector comprises setting the three polynomial matrix filters by searching for a maximum order and coefficients for each order for each similarity matrix so that each of the three similarity matrices has required low-pass filtering characteristics.

5. The group recommendation method of claim 4, wherein the step of obtaining the predicted score vector comprises obtaining the three polynomial matrix filters by searching for the maximum order and the coefficients according to the following equation:
$${f}_{1} ( {\overline{P}}_{u} ) = {\sum }_{k = 1}^{{K}_{u}} {a}_{k} {\overline{P}}_{u}^{k} ;$$
$${f}_{2} ( {\overline{P}}_{g} ) = {\sum }_{k = 1}^{{K}_{g}} {b}_{k} {\overline{P}}_{g}^{k} ;$$
$${f}_{3} ( {\overline{P}}_{uni} ) = {\sum }_{k = 1}^{{K}_{uni}} {c}_{k} {\overline{P}}_{uni}^{k} ,$$
wherein f₁(P̅ᵤ), f₂(P̅_{g}), f₃(P̅ᵤₙᵢ) are polynomial matrix filters, aₖ, bₖ, and cₖ are the coefficients for each order (k), and Kᵤ, K_{g}, and Kᵤₙᵢ denote the maximum order of each polynomial matrix filter.

6. The group recommendation method of claim 1, wherein the step of obtaining the predicted score vector comprises obtaining the final polynomial matrix filter from the three polynomial matrix filters according to the following equation:
f(P̅ᵤ;P̅_{g};P̅ᵤₙᵢ)=(1−α−β)f₁(P̅ᵤ)+αf₂(P̅_{g})+βf₃(P̅ᵤₙᵢ)
wherein f(P̅ᵤ; P̅_{g}; P̅ᵤₙᵢ) is the final polynomial matrix filter, f₁(P̅ᵤ), f₂(P̅_{g}), f₃(P̅ᵤₙᵢ) are three polynomial matrix filters, and α and β are hyperparameters for adjusting a balance among the three polynomial matrix filters f₁(P̅ᵤ), f₂(P̅_{g}), f₃(P̅ᵤₙᵢ).

7. The group recommendation method of claim 1, wherein the step of obtaining the predicted score vector comprises:
when a row vector corresponding to the item recommendation target group in the group-item matrix is selected, obtaining the predicted score vector by multiplying the selected row vector by the final polynomial matrix filter; and searching for and obtaining an item corresponding to an element with the largest element value in the predicted score vector as a group recommendation item.

8. The group recommendation method of claim 1, wherein the group recommendation method is performed by a processor of an apparatus comprising a memory and a processor.

9. A group recommendation apparatus, comprising: a memory; and a processor configured to execute at least part of operations according to a program stored in the memory,
wherein the processor is configured to:
obtain a member-item matrix representing relationships between users and items, a group-item matrix representing relationships between groups and items, and a member-group matrix representing memberships of users in groups;
combine the member-group matrix with the member-item matrix and the group-item matrix, respectively, to obtain an augmented member-item matrix and an augmented group-item matrix, and integrate the member-item matrix and the group-item matrix to obtain a unified matrix;
obtain three similarity matrices representing a similarity between items associated with users, a similarity between items associated with groups, and a similarity between items jointly associated with members and groups, from the augmented member-item matrix, the augmented group-item matrix, and the unified matrix; and
set three polynomial matrix filters for the three similarity matrices, and filter a row vector corresponding to an item recommendation target group in the group-item matrix with a final polynomial matrix filter composed of the three polynomial matrix filters, to obtain a predicted score vector.

10. The group recommendation apparatus of claim 9, wherein the processor is further configured to:
multiply the augmented member-item matrix, the augmented group-item matrix, and the unified matrix each by their respective transpose matrices to obtain the three similarity matrices.

11. The group recommendation apparatus of claim 9, wherein the processor is further configured to:
symmetrically normalize each of the augmented member-item matrix, the augmented group-item matrix, and the unified matrix so that mutual influence between nodes of different natures becomes equal in magnitude, thereby obtaining a normalized member matrix, a normalized group matrix, and a normalized unified matrix, and obtain the three similarity matrices based on the normalized member matrix, the normalized group matrix, and the normalized unified matrix.

12. The group recommendation apparatus of claim 9, wherein the processor is further configured to:
set the three polynomial matrix filters by searching for a maximum order and coefficients for each order for each similarity matrix so that each of the three similarity matrices has required low-pass filtering characteristics.

13. The group recommendation apparatus of claim 12, wherein the processor is further configured to:
obtain the three polynomial matrix filters by searching for the maximum order and the coefficients according to the following equation:
$${f}_{1} ( {\overline{P}}_{u} ) = {\sum }_{k = 1}^{{K}_{u}} {a}_{k} {\overline{P}}_{u}^{k} ;$$
$${f}_{2} ( {\overline{P}}_{g} ) = {\sum }_{k = 1}^{{K}_{g}} {b}_{k} {\overline{P}}_{g}^{k} ;$$
$${f}_{3} ( {\overline{P}}_{uni} ) = {\sum }_{k = 1}^{{K}_{uni}} {c}_{k} {\overline{P}}_{uni}^{k} ,$$
wherein f₁(P̅ᵤ), f₂(P̅_{g}), f₃(P̅ᵤₙᵢ) are polynomial matrix filters, aₖ, bₖ, and cₖ are the coefficients for each order (k), and Kᵤ, K_{g}, and Kᵤₙᵢ denote the maximum order of each polynomial matrix filter.

14. The group recommendation apparatus of claim 9, wherein the processor is further configured to:
obtain the final polynomial matrix filter from the three polynomial matrix filters according to the following equation:
f(P̅ᵤ;P̅_{g};P̅ᵤₙᵢ)=(1−α−β)f₁(P̅ᵤ)+αf₂(P̅_{g})+βf₃(P̅ᵤₙᵢ)
wherein f(P̅ᵤ; P̅_{g}; P̅ᵤₙᵢ) is the final polynomial matrix filter, f₁(P̅ᵤ), f₂(P̅_{g}), f₃(P̅ᵤₙᵢ) are three polynomial matrix filters, and α and β are hyperparameters for adjusting a balance among the three polynomial matrix filters f₁(P̅ᵤ), f₂(P̅_{g}), f₃(P̅ᵤₙᵢ).

15. The group recommendation apparatus of claim 9, wherein, when a row vector corresponding to the item recommendation target group in the group-item matrix is selected, the processor is further configured to:
obtain the predicted score vector by multiplying the selected row vector by the final polynomial matrix filter; and search for and obtain an item corresponding to an element with the largest element value in the predicted score vector as a group recommendation item.
